(19) United States
(12) Patent Application Publication
(10) Pub. No.: US 2023/0386440 A1
(43) Pub. Date: Nov. 30, 2023

(54) SOUND GENERATION METHOD USING MACHINE LEARNING MODEL, TRAINING METHOD FOR MACHINE LEARNING MODEL, SOUND GENERATION DEVICE, TRAINING DEVICE, NON-TRANSITORY COMPUTER-READABLE MEDIUM STORING SOUND GENERATION PROGRAM, AND NON-TRANSITORY COMPUTER-READABLE MEDIUM STORING TRAINING PROGRAM

(71) Applicant: Yamaha Corporation, Hamamatsu (JP)

(72) Inventors: Keijiro SAINO, Hamamatsu (JP); Ryunosuke DAIDO, Hamamatsu (JP); Bonada JORDI, Andalucía (ES); Blaauw MERLIJN, Catalunya (ES)

(21) Appl. No.: 18/447,051

(22) Filed: Aug. 9, 2023

Related U.S. Application Data
(63) Continuation of application No. PCT/JP2021/045962, filed on Dec. 14, 2021.

(30) Foreign Application Priority Data
Feb. 10, 2021 (JP) 2021-020117

(51) Int. Cl. G10H 1/12; G10H 3/12

(52) U.S. Cl. CPC G10H 1/12; G10H 3/125; G10H 2210/031; G10H 2250/311; G10H 2250/551

(57) ABSTRACT

A sound generation method that is realized by a computer includes receiving a first feature amount sequence in which a musical feature amount changes over time, and using a trained model that has learned an input-output relationship between an input feature amount sequence in which the musical feature amount changes over time at a first fineness and a reference sound data sequence corresponding to an output feature amount sequence in which the musical feature amount changes over time at a second fineness that is higher than the first fineness, to process the first feature amount sequence, thereby generating a sound data sequence corresponding to a second feature amount sequence in which the musical feature amount changes at the second fineness.

### CROSS-REFERENCE TO RELATED APPLICATIONS

This application is a continuation application of International Application No. PCT/JP2021/045962, filed on Dec. 14, 2021, which claims priority to Japanese Patent Application No. 2021-020117 filed in Japan on Feb. 10, 2021. The entire disclosures of International Application No. PCT/JP2021/045962 and Japanese Patent Application No. 2021-020117 are hereby incorporated herein by reference.

### BACKGROUND

### Technological Field

The present disclosure relates to a sound generation method, a training method, a sound generation device, a training device, a sound generation program, and a training program capable of generating sound.

### Background Information

Applications that generate sound signals based on a time series of sound volumes specified by a user are known. For example, in the application disclosed in Jesse Engel; Lamtharn Hantrakul, Chenjie Gu and Adam Roberts, “DDSP: Differentiable Digital Signal Processing,” arXiv:2001.04643v1 [cs.LG] 14 Jan. 2020, the fundamental frequency, hidden variables, and loudness are extracted as feature amounts from sound input by a user. The extracted feature amounts are subjected to spectral modeling synthesis in order to generate sound signals.

### SUMMARY

In order to use the application disclosed in Jesse Engel; Lamtharn Hantrakul, Chenjie Gu and Adam Roberts, “DDSP: Differentiable Digital Signal Processing,” arXiv:2001.04643v1 [cs.LG] 14 Jan. 2020 to generate a sound signal that represents naturally changing sound, such as that of a person singing or performing, the user must specify in detail a time series of musical feature amounts, such as amplitude, volume, pitch, timbre, etc. However, it is not easy to specify in detail a time series of musical feature amounts, such as amplitude, volume, pitch, and timbre.

An object of this disclosure is to provide a sound generation method, a training method, a sound generation device, a training device, a sound generation program, and a training program with which natural sounds can be easily acquired.

A sound generation method according to one aspect of this disclosure is realized by a computer, comprising receiving a first feature amount sequence in which a musical feature amount changes over time, and using a trained model that has learned an input-output relationship between an input feature amount sequence in which the musical feature amount changes over time at a first fineness and a reference sound data sequence corresponding to an output feature amount sequence in which the musical feature amount changes over time at a second fineness that is higher than the first fineness, to process the first feature amount sequence, thereby generating a sound data sequence corresponding to a second feature amount sequence in which the musical feature amount changes at the second fineness. The term “musical feature amount” indicates that the feature amount is of a musical type (such as amplitude, pitch, and timbre). The first feature amount sequence, the input feature amount sequence, the output feature amount sequence, and the second feature amount sequence are all examples of time-series data of a “musical feature amount (feature amount).” That is, the feature amounts for which changes are indicated in each of the first feature amount sequence, the input feature amount sequence, the output feature amount sequence, and the second feature amount sequence are all “musical feature amounts.”

A training method according to another aspect of this disclosure is realized by a computer, comprising extracting, from reference data representing a sound waveform, a reference sound data sequence in which a musical feature amount changes over time at a prescribed fineness and an output feature amount sequence that is a time series of the musical feature amount; generating, from the output feature amount sequence, an input feature amount sequence in which the musical feature amount changes over time at a lower fineness than the prescribed fineness; and constructing a trained model that has learned an input-output relationship between the input feature amount sequence and the reference sound data sequence by machine learning using the input feature amount sequence and the reference sound data sequence.

A sound generation device according to another aspect of this disclosure comprises at least one processor configured to receive a first feature amount sequence in which a musical feature amount changes over time, and use a trained model that has learned an input-output relationship between an input feature amount sequence in which the musical feature amount changes over time at a first fineness and a reference sound data sequence corresponding to an output feature amount sequence in which the musical feature amount changes over time at a second fineness that is higher than the first fineness, to process the first feature amount sequence, thereby generating a sound data sequence corresponding to a second feature amount sequence in which the musical feature amount changes at the second fineness.

A training device according to another aspect of this disclosure comprises at least one processor configured to extract, from reference data representing a sound waveform, a reference sound data sequence in which a musical feature amount changes over time at a prescribed fineness and an output feature amount sequence, which is a time series of the musical feature amount; generate, from the output feature amount sequence, an input feature amount sequence in which the musical feature amount changes over time at a lower fineness than the prescribed fineness; and construct a trained model that has learned an input-output relationship between the input feature amount sequence and the reference sound data sequence by machine learning using the input feature amount sequence and the reference sound data sequence.

### BRIEF DESCRIPTION OF THE DRAWINGS

FIG. 1 is a block diagram showing the configuration of a processing system including a sound generation device and a training device according to a first embodiment of this disclosure.

FIG. 2 is a block diagram illustrating the configuration of the sound generation device.

FIG. 3 is a diagram for explaining an operation example of the sound generation device.

FIG. 4 is a diagram for explaining an operation example of the sound generation device.

FIG. 5 is a diagram for explaining another operation example of the sound generation device.

FIG. 6 is a block diagram showing a configuration of a training device.

FIG. 7 is a diagram for explaining an operation example of the training device.

FIG. 8 is a flowchart showing an example of the sound generation process carried out by the sound generation device of FIG. 2.

FIG. 9 is a flowchart showing an example of the training process carried out by the training device of FIG. 6.

FIG. 10 is a diagram showing an example of a reception screen in a second embodiment.

### DETAILED DESCRIPTION OF THE EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

(1) Configuration of a Processing System

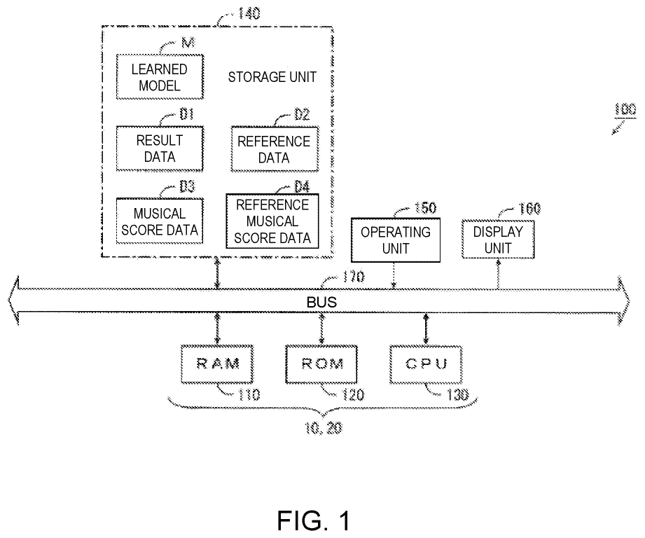

A sound generation method, a training method, a sound generation device, a training device, a sound generation program, and a training program according to a first embodiment of this disclosure will be described in detail below with reference to the drawings. FIG. 1 is a block diagram showing the configuration of a processing system including a sound generation device and a training device according to an embodiment. As shown in FIG. 1, a processing system 100 includes a RAM (random-access memory) 110, a ROM (read-only memory) 120, a CPU (central processing unit) 130, a storage unit 140, an operating unit 150, and a display unit 160. The CPU 130, as a central processing unit, can be, or include, one or more of a CPU, MPU (Microprocessing Unit), GPU (Graphics Processing Unit), ASIC (Application Specific Integrated Circuit), FPGA (Field Programmable Gate Array), DSP (Digital Signal Processor), and a general-purpose computer. The CPU 130 is one example of at least one processor included in an electronic controller of the sound generation device and/or the training device. Here, the term “electronic controller” as used herein refers to hardware, and does not include a human.

The processing system 100 is realized by a computer, such as a PC, a tablet terminal, or a smartphone. Alternatively, the processing system 100 can be realized by co-operative operation of a plurality of computers connected by a communication channel, such as the Internet. The RAM 110, the ROM 120, the CPU 130, the storage unit 140, the operating unit 150, and the display unit 160 are connected to a bus 170. The RAM 110, the ROM 120, and the CPU 130 constitute a sound generation device 10 and a training device 20. In the present embodiment, the sound generation device 10 and the training device 20 are configured by the common processing system 100, but they can be configured by separate processing systems.

The RAM 110 consists of volatile memory, for example, and is used as a work area of the CPU 130. The ROM 120 consists of non-volatile memory, for example, and stores a sound generation program and a training program. The CPU 130 executes a sound generation program stored in the ROM 120 on the RAM 110 in order to carry out a sound generation process. Further, the CPU 130 executes the training program stored in the ROM 120 on the RAM 110 in order to carry out a training process. Details of the sound generation process and the training process will be described below.

The sound generation program or the training program can be stored in the storage unit 140 instead of the ROM 120. Alternatively, the sound generation program or the training program can be provided in a form stored on a computer-readable storage medium and installed in the ROM 120 or the storage unit 140. Alternatively, if the processing system 100 is connected to a network, such as the Internet, a sound generation program distributed from a server (including a cloud server) on the network can be installed in the ROM 120 or the storage unit 140. Each of the storage unit 140 and the ROM 120 is an example of a non-transitory computer-readable medium.

The storage unit 140 includes a storage medium, such as a hard disk, an optical disk, a magnetic disk, or a memory card. The storage unit 140 stores a trained model M, result data D1, a plurality of pieces of reference data D2, a plurality of pieces of musical score data D3, and a plurality of pieces of reference musical score data D4. The plurality of pieces of reference data D2 and the plurality of pieces of reference musical score data D4 correspond to each other. That the reference data D2 (sound data) and the reference musical score data D4 (musical score data) “correspond” means that each note (and phoneme) of a musical piece indicated by a musical score indicated by the reference musical score data D4, and each note (and phoneme) of a musical piece indicated by waveform data indicated by the reference data D2 are identical to each other, including their performance timings, performance intensities, and performance expressions. The trained model M is a generative model for receiving a musical score feature amount sequence of the musical score data D3 and a control value (input feature amount sequence), and estimating the result data D1 (sound data sequence) in accordance with the musical score feature amount sequence and the control value. The trained model M learns an input-output relationship between the musical score feature amount sequence as well as the input feature amount sequence, and the reference sound data sequence corresponding to the output feature amount sequence, and is constructed by the training device 20. In the present embodiment, the trained model M is an AR (regression) type generative model, but can also be a non-AR type generative model.

The input feature amount sequence is a time series (time-series data) in which a musical feature amount changes over time at a first fineness, for example, a time series in which a musical feature amount gradually changes discretely or intermittently for each time portion of sound. The output feature amount sequence is a time series (time-series data) in which a musical feature amount changes over time at a second fineness higher than the first fineness, for example, a time series in which a musical feature amount changes quickly and steadily or continuously. Each of the input feature amount sequence and the output feature amount sequence is a feature amount sequence, that is time-series data of a musical feature amount, in other words, data indicating temporal changes in a musical feature amount. A musical feature amount can be, for example, amplitude or a derivative value thereof, or pitch or a derivative value thereof. Instead of amplitude, etc., a musical feature amount can include spectral the gradient or spectral centroid or a ratio (high-frequency power/low-frequency power) of high-frequency power to low-frequency power. The term “musical feature amount” indicates that the feature amount is of a musical type (such as amplitude, pitch, and timbre), and can be shortened and referred to simply as a “feature amount” below. The input feature amount sequence, the output feature amount sequence, the first feature amount sequence, and the second feature amount sequence in the present embodiment are all examples of time-series data of a “musical feature amount (feature amount).” That is, all of the feature amounts for which changes are shown in each of the input feature amount sequence, the output feature amount sequence, the first feature amount sequence, and the second feature amount sequence are “musical feature amounts.” On the other hand, the sound data sequence is a sequence of frequency-domain data that can be converted into time-domain sound waveforms, and can be a combination of a time series of pitch and a time series of amplitude spectrum envelope of a waveform, a mel spectrogram, or the like.

Here, fineness does not mean the number of feature amounts within a unit of time (temporal resolution), but rather the frequency of changes in the feature amount within a unit of time, the content ratio (content percentage) of the high-frequency components within a unit of time, or the amount of the high-frequency components contained within a unit of time. That is, the input feature amount sequence is a feature amount sequence obtained by reducing the fineness of the output feature amount sequence, for example, a feature amount sequence obtained by processing the output feature amount sequence so that a large portion thereof is the same as the immediately preceding value, or, a feature amount sequence obtained by applying a certain type of low-pass filter to the output feature amount sequence. Here, the temporal resolution does not differ between the input feature amount sequence and the output feature amount sequence.

The result data D1 represent a sound data sequence corresponding to the feature amount sequence (second feature amount sequence mentioned below) of sound generated by the sound generation device 10. The reference data D2 are waveform data used to train the trained model M, that is, a time series (time-series data) of sound waveform samples. The time series (time-series data) of the feature amount (for example, amplitude) extracted from each piece of waveform data in relation to sound control is referred to as the output feature amount sequence. The musical score data D3 and the reference musical score data D4 each represent a musical score including a plurality of musical notes (sequence of notes) arranged on a time axis. The musical score feature amount sequence generated from the musical score data D3 is used by the sound generation device 10 to generate the result data D1. The reference data D2 and the reference musical score data D4 are used by the training device 20 to construct the trained model M.

The trained model M, the result data D1, the reference data D2, the musical score data D3, and the reference musical score data D4 can be stored in a computer-readable storage medium instead of the storage unit 140. Alternatively, in the case that the processing system 100 is connected to a network, the trained model M, the result data D1, the reference data D2, the musical score data D3, or the reference musical score data D4 can be stored in a server on said network.

The operating unit (user operable input(s)) 150 includes a keyboard or a pointing device such as a mouse and is operated by a user in order to make prescribed inputs. The display unit (display) 160 includes a liquid-crystal display, for example, and displays a prescribed GUI (Graphical User Interface) or the result of the sound generation process. The operating unit 150 and the display unit 160 can be formed by a touch panel display.

(2) Sound Generation Device

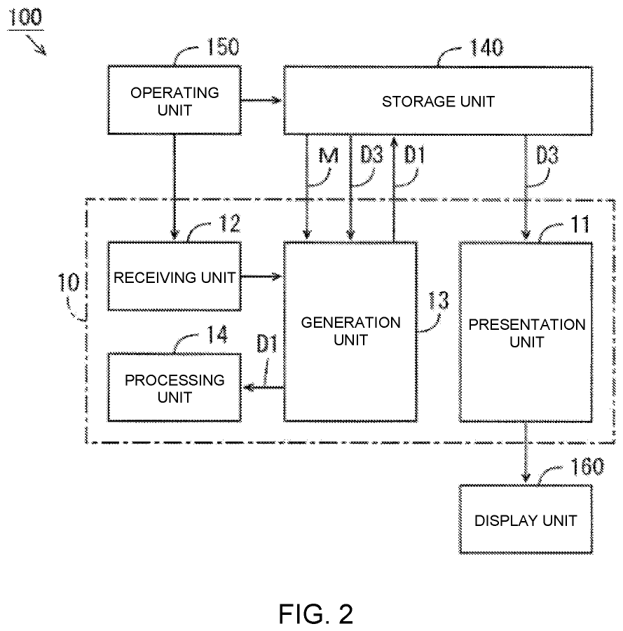

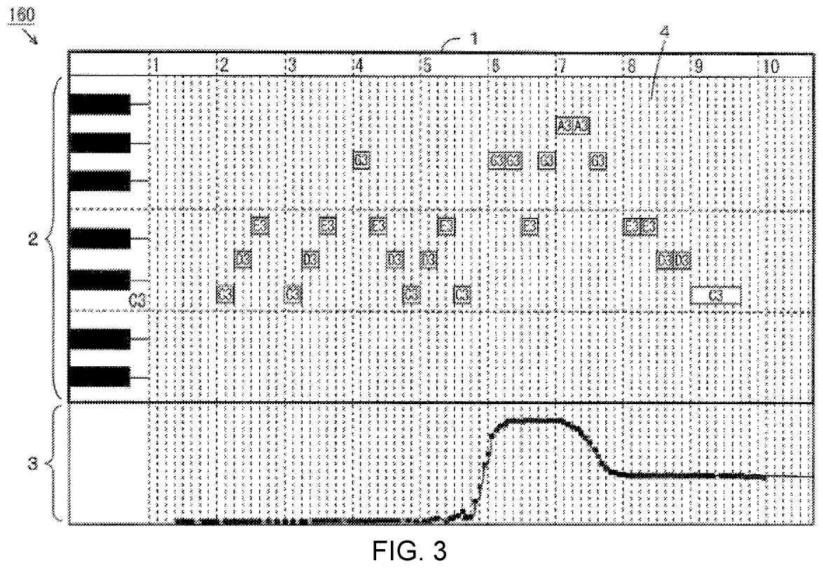

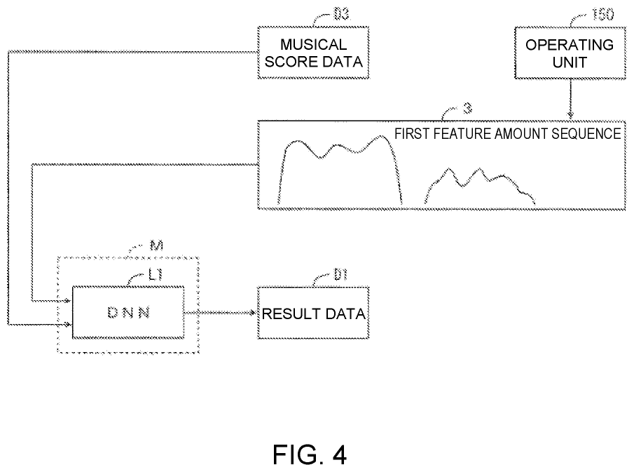

FIG. 2 is a block diagram illustrating a configuration of the sound generation device 10. FIGS. 3 and 4 are diagrams for explaining operation examples of the sound generation device 10. As shown in FIG. 2, the sound generation device 10 includes a presentation unit 11, a receiving unit 12, a generation unit 13, and a processing unit 14. The functions of the presentation unit 11, the receiving unit 12, the generation unit 13, and the processing unit 14 are realized by the CPU 130 of FIG. 1 executing the sound generation program. At least a part of the presentation unit 11, the receiving unit 12, the generation unit 13, and the processing unit 14 can be realized in hardware such as electronic circuitry.

As shown in FIG. 3, the presentation unit 11 displays a reception screen 1 on the display unit 160 as a GUI for receiving input from the user. The reception screen 1 is provided with a reference area 2 and an input area 3. For example, a reference image 4, which represents the positions of a plurality of musical notes on a time axis, is displayed in the reference area 2 based on the musical score data D3 selected by the user. The reference image 4 is, for example, a piano roll. By operating the operating unit 150, the user can edit or select the musical score data D3 representing the desired musical score from a plurality of pieces of the musical score data D3 stored in the storage unit 140 or the like.

The input area 3 is arranged to correspond to the reference area 2. The user uses the operating unit 150 shown in FIG. 1 and, while looking at the musical note of the reference image 4, coarsely inputs each feature amount in the input area 3 such that the feature amount (amplitude, in this example) varies with time. This allows the first feature amount sequence to be input. In the input example of FIG. 3, the amplitude is input such that the amplitude in the first through fifth measures of the musical score is small, the amplitude in the sixth to seventh measures is large, and the amplitude in the eighth to tenth measures is slightly larger. The receiving unit 12 accepts the first feature amount sequence input on the input area 3.

As shown in FIG. 4, the trained model M stored in the storage unit 140 or the like includes, for example, a neural network (DNN (deep neural network) L1 in the example of FIG. 4). The musical score data D3 selected by the user and the first feature amount sequence input into the input area 3 are provided to the DNN L1. The generation unit 13 uses the DNN L1 to process the musical score data D3 and the first feature amount sequence, thereby generating the result data D1, which is, for example, a combination of a time series of amplitude spectral envelopes and a time series of pitch in the musical score. The result data D1 indicate a sound data sequence corresponding to the second feature amount sequence in which the amplitude changes at a second fineness. Further, in the time series of pitch included in the result data D1, the pitch changes with a high fineness (fineness that is higher than the fineness of the first feature amount sequence), in accordance with the first feature amount sequence (in the same manner as the amplitude). The result data can be the result data D1, which is a time series (for example, mel spectrogram) of the amplitude spectra in the musical score.

The amplitude at each time point in the first feature amount sequence can be a representative value of the amplitude in a prescribed period of time (prescribed time period) including said time point in the second feature amount sequence. The interval between two adjacent time points is, for example, 5 ms, the length of the prescribed period of time is for example, 3 s, and each time point is located at the center of the corresponding prescribed period of time, for example. The representative value can be a statistical value of the amplitude in a prescribed period of time in the second feature amount sequence. For example, the representative value can be the maximum value, the mean value, the median value, the mode, the variance, or the standard deviation of the amplitude.

However, the representative value is not limited to a statistical value of the amplitude in a prescribed period of time in the second feature amount sequence. For example, the representative value can be the ratio of the maximum value of the first harmonic to the maximum value of the second harmonic of the amplitude in a prescribed period of time in the second feature amount sequence, or the logarithm of this ratio. Alternatively, the representative value can be the average value of the maximum value of the first harmonic and the maximum value of the second harmonic described above.

The generation unit 13 can store the generated result data D1 in the storage unit 140 or the like. The processing unit 14 functions as a vocoder, for example, and generates a sound signal representing a time-domain waveform from the frequency-domain result data D1 generated by the generation unit 13. By supplying the generated sound signal to a sound system that includes speakers, etc., connected to the processing unit 14, sound based on the sound signal is output. In the present embodiment, the sound generation device 10 includes the processing unit 14 but the embodiment is not limited in this way. The sound generation device 10 need not include the processing unit 14.

In the example of FIG. 3, the input area 3 is arranged beneath the reference area 2 on the reception screen 1, but the embodiment is not limited in this way. The input area 3 can be arranged above the reference area 2 on the reception screen 1. Alternatively, the input area 3 can be arranged to overlap the reference area 2 on the reception screen 1.

Further, in the example of FIG. 3, the reception screen 1 includes the reference area 2, and the reference image 4 is displayed in the reference area 2, but the embodiment is not limited in this way. The reception screen 1 need not include the reference area 2. In this case, the user uses the operating unit 150 to draw the desired time series of amplitude in the input area 3. This allows the user to coarsely input the first feature amount sequence in which the amplitude changes.

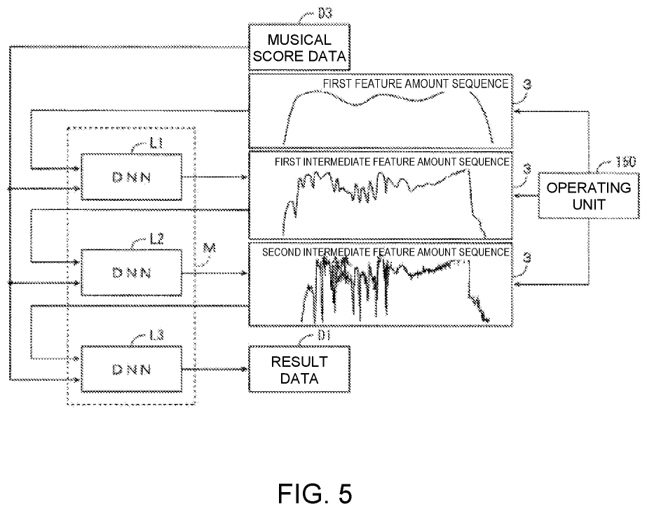

In the example of FIG. 4, the trained model M includes one DNN L1, but the embodiment is not limited in this way. The trained model M can include a plurality of DNNs. FIG. 5 is a diagram for explaining another operation example of the sound generation device 10. In the example of FIG. 5, the trained model M includes three DNNs: L1, L2, and L3. The musical score data D3 selected by the user are provided to each DNN L1-L3. In addition, the first feature amount sequence input to the input area 3 by the user is provided to the DNN L1.

The generation unit 13 uses the DNN L1 to processes the musical score data D3 and the first feature amount sequence, thereby generating a first intermediate feature amount sequence in which the amplitude changes over time. The fineness of the time series of amplitude in the first intermediate feature amount sequence is higher than the fineness (first fineness) of the time series of amplitude in the first feature amount sequence. The first intermediate feature amount sequence can be displayed in the input area 3. The user can use the operating unit 150 to correct the first intermediate feature amount sequence displayed in the input area 3.

Further, the generation unit 13 uses DNN L2 to process the musical score data D3 and the first intermediate feature amount sequence, thereby generating a second intermediate feature amount sequence in which the amplitude changes over time. The fineness of the time series of amplitude in the second intermediate feature amount sequence is higher than the fineness of the time series of amplitude in the first intermediate feature amount sequence. The second intermediate feature amount sequence can be displayed in the input area 3. The user can use the operating unit 150 to correct the second intermediate feature amount sequence displayed in the input area 3.

Further, the generation unit 13 uses the DNN L3 to process the musical score data D3 and the second intermediate feature amount sequence, thereby identifying the time series of pitch in the musical score and generate the result data D1 representing the identified time series of pitch. The fineness (second fineness) of the time series of amplitude in the second feature amount sequence represented by the result data D1 is higher than the fineness of the time series of amplitude in the second intermediate feature amount sequence. As described above, when a feature amount sequence (input feature amount sequence, first feature amount sequence) in which the feature amount (for example, amplitude) changes over time at a first fineness is input, L1 can output the first intermediate feature amount sequence in which the feature amount changes over time at a higher fineness than the first fineness. When the first intermediate feature amount sequence is input, L2 can output the second intermediate feature amount sequence in which the feature amount changes over time at a higher fineness than the fineness of the first intermediate feature amount sequence. When the second intermediate feature amount sequence is input, L3 can identify the time series of pitch in the musical score and output a sound data sequence (reference sound data sequence, result data D1) representing the identified time series of pitch. The time-series data of the waveform feature amount corresponding to the sound data sequence output by L3 are referred to as the second feature amount sequence. In the second feature amount sequence, the feature amount changes over time at a higher fineness than the fineness of the second intermediate feature amount sequence, that is, the fineness (second fineness) of the second feature amount sequence is higher than the fineness of the second intermediate feature amount sequence. The musical score data corresponding to the sound data sequence output by L3 (reference musical score data D4, musical score data D3) and/or the musical score feature amount generated from the musical score data can also be input to each of L1, L2, and L3. The musical score data represent a musical score that includes a plurality of musical notes (sequence of notes) arranged on a time axis.

(3) Training Device

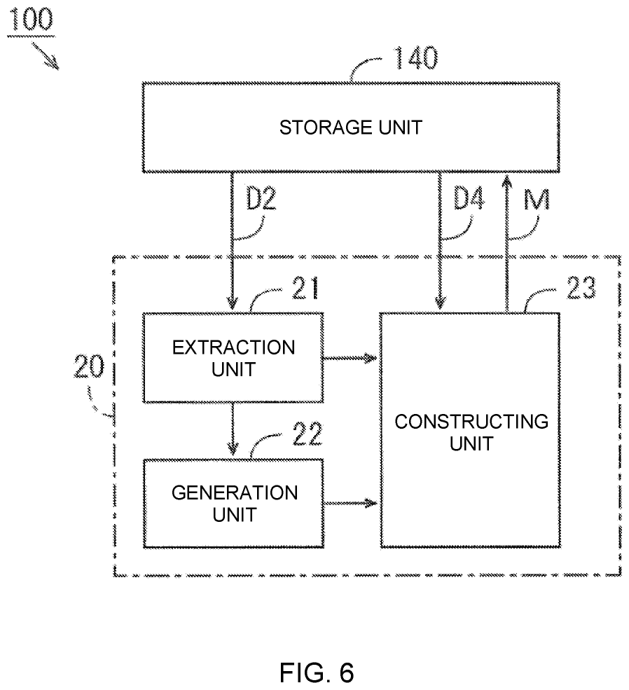

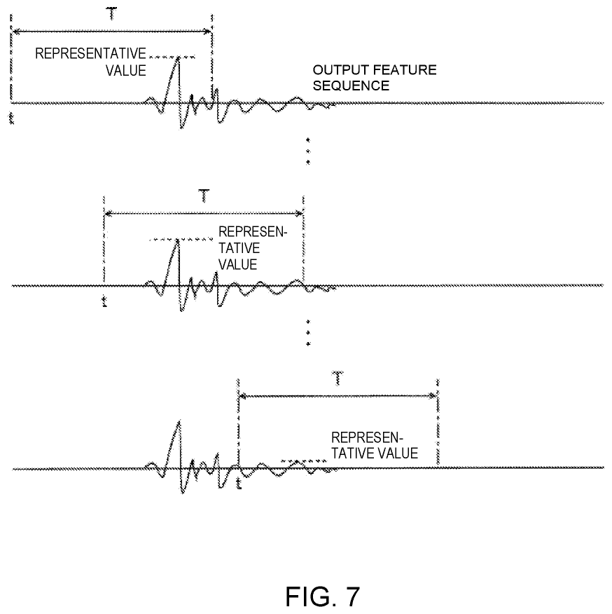

FIG. 6 is a block diagram showing a configuration of the training device 20. FIG. 7 is a diagram for explaining an operation example of the training device 20. As shown in FIG. 6, the training device 20 includes an extraction unit 21, a generation unit 22, and a construction unit 23. The functions of the extraction unit 21, the generation unit 22, and the construction unit 23 are realized by the CPU 130 of FIG. 1 executing a training program. At least a part of the extraction unit 21, the generation unit 22, and the construction unit 23 can be realized in hardware such as electronic circuitry.

The extraction unit 21 extracts a reference sound data sequence and an output feature amount sequence from each of the plurality of pieces of the reference data D2 stored in the storage unit 140 or the like. The reference sound data sequence are data representing a frequency-domain spectrum of the time-domain waveform represented by the reference data D2 and can be a combination of a time series of pitch and a time series of amplitude spectrum envelope of a waveform represented by corresponding reference data D2, a mel spectrogram, etc. Frequency analysis of the reference data D2 using a prescribed time frame generates a sequence of reference sound data at prescribed intervals (for example, 5 ms). The output feature amount sequence is a time series of a feature amount (for example, amplitude) of the waveform corresponding to the reference sound data sequence which changes over time at a prescribed fineness corresponding to the prescribed interval (for example, 5 ms). The data interval in each type of data sequence can be shorter or longer than 5 ms, and can be the same as or different from each other. The generation unit 22 generates an input feature amount sequence from each of the plurality of output feature amount sequences. In the input feature amount sequence, the feature amount (for example, amplitude) changes over time at a fineness that is lower than the fineness of the time series of the feature amount (for example, amplitude) in the output feature amount sequence.

Specifically, as shown in FIG. 7, the generation unit 22 extracts a representative value of the amplitude within a prescribed period of time (prescribed time period) T including each time point t, in the output feature amount sequence. The interval between two adjacent time points t is 5 ms, for example, the length of the time period is 3 s, for example, and each time point t is positioned at the center of the time period T. In the example of FIG. 7, the representative value of the amplitude of each time period T is the maximum value of the amplitude within said time period T, but can be other statistical values, etc., of the amplitude within the time period T. The generation unit 22 generates the input feature amount sequence by arranging the representative values of the extracted amplitudes of the plurality of time periods T as the respective amplitudes of a plurality of time points tin the input feature amount sequence. The maximum value of the amplitude remains the same for a period of up to 3 s, and the interval at which the value changes is several tens of times longer compared to the interval 5 ms of time points. That is, the frequency of change is lower, i.e., the fineness is lower, for the input feature amount sequence as compared to the output feature amount sequence.

The constructing unit 23 prepares an (untrained or pre-trained) generative model m composed of a DNN and trains the generative model m based on the extracted reference sound data sequence, and based on the generated input feature amount sequence and the musical score feature amount sequence that is generated from each piece of the reference musical score data D4 stored in the storage unit 140 or the like. By this training, the trained model M, which has learned the input-output relationship between the musical score feature amount sequence as well as the input feature amount sequence, and the reference sound data sequence, is constructed. The prepared generative model m can include one DNN L1, as shown in FIG. 4, or include a plurality of DNNs L1-L3, as shown in FIG. 5. The constructing unit 23 stores the constructed trained model M in the storage unit 140 or the like.

(4) Sound Generation Process

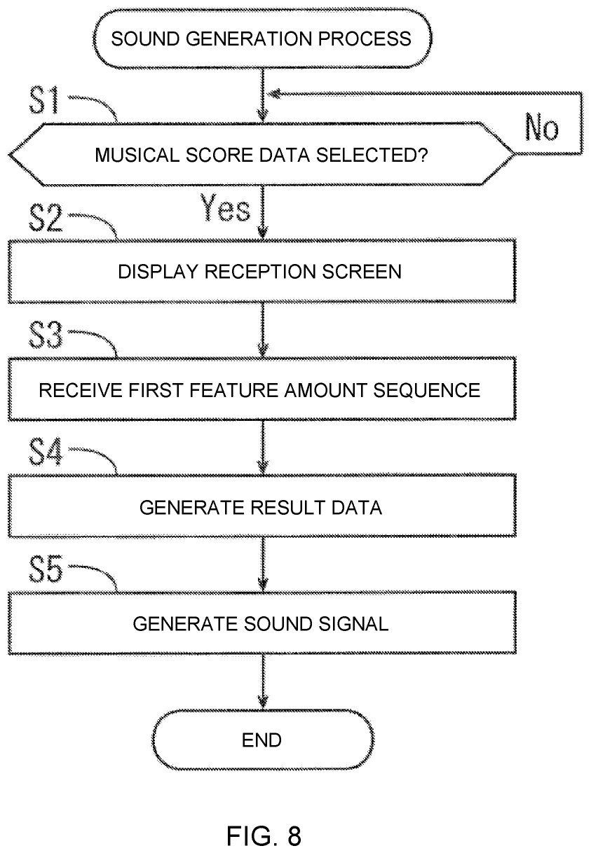

FIG. 8 is a flowchart showing one example of a sound generation process carried out by the sound generation device 10 of FIG. 2. The sound generation process of FIG. 8 is performed by the CPU 130 of FIG. 1 executing a sound generation program stored in the storage unit 140 or the like. First, the CPU 130 determines whether the user has selected the musical score data D3 (Step S1). If the musical score data D3 have not been selected, the CPU 130 waits until the musical score data D3 are selected.

If the musical score data D3 have been selected, the CPU 130 causes the display unit 160 to display the reception screen 1 of FIG. 3 (Step S2). The reference image 4 based on the musical score data D3 selected in Step S1 is displayed in the reference area 2 of the reception screen 1. The CPU 130 then accepts the first feature amount sequence on the input area 3 of the reception screen 1 (Step S3).

The CPU 130 then uses the trained model M to process the musical score feature amount sequence of the musical score data D3 selected in Step S1 and the first feature amount sequence received in Step S3, thereby generating the result data D1 (Step S4). The CPU 130 then generates a sound signal, which is a time-domain waveform, from the result data D1 generated in Step S4 (Step S5) and terminates the sound generation process.

(5) Training Process

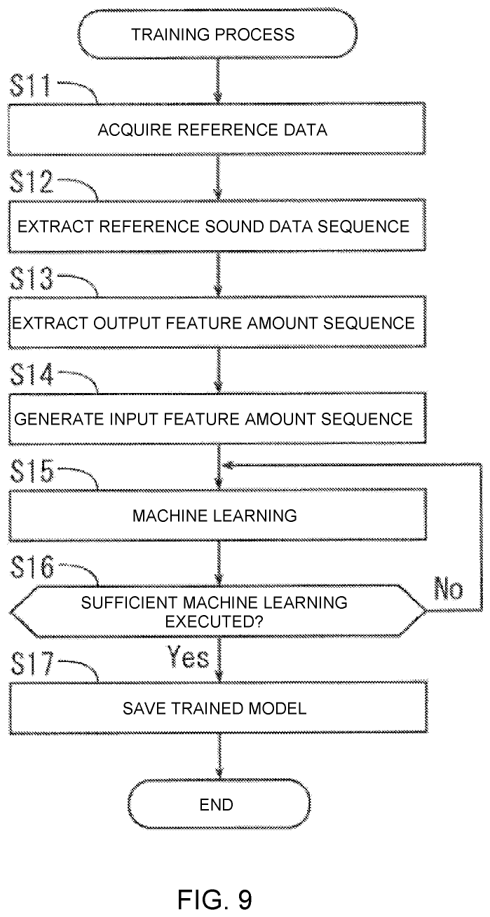

FIG. 9 is a flowchart showing an example of a training process performed by the training device 20 of FIG. 6. The training process of FIG. 9 is performed by the CPU 130 of FIG. 1 executing a training program stored in the storage unit 140 or the like. First, the CPU 130 acquires the plurality of pieces of reference data D2 used for training from the storage unit 140 or the like (Step S11). The CPU 130 then extracts a reference sound data sequence from each piece of the reference data D2 acquired in Step S11 (Step S12). Further, the CPU 130 extracts an output feature amount sequence (for example, time series of amplitude) from each piece of the reference data D2 acquired in Step S1 (Step S13).

The CPU 130 then generates an input feature amount sequence (time series of maximum values of amplitude) from the output feature amount sequence extracted in Step S3 (Step S14). The CPU 130 then prepares the generative model m to train the generative model m based on the musical score feature amount sequence based on the reference musical score data D4 corresponding to each piece of the reference data D2 acquired in Step S11 and the input feature amount sequence generated in Step S14, and based on the reference sound data sequence extracted in Step S12, thereby teaching the generative model m, by machine learning, the input-output relationship between the musical score feature amount sequence as well as the input feature amount sequence, and the reference sound data sequence (Step S15).

The CPU 130 then determines whether sufficient machine learning has been performed to allow the generative model m to learn the input-output relationship (Step S16). If insufficient machine learning has been performed, the CPU 130 returns to Step S15. Steps S15-S16 are repeated while changing the parameters until sufficient machine learning is performed. The number of machine learning iterations varies as a function of the quality conditions that must be satisfied by the trained model M to be constructed. The determination of Step S16 is carried out based on a loss function, which is an index of the quality conditions. For example, if the loss function, which indicates the difference between the sound data sequence output by the generative model m with respect to the input feature amount sequence that has been input and the reference sound data sequence that is attached as a label to the input feature amount sequence that has been input, is smaller than a prescribed value, machine learning is determined to be sufficient. The prescribed value can be set by the user of the processing system 100 as deemed appropriate, in accordance with the desired quality (quality conditions). Instead of such a determination, or together with such a determination, it can be determined whether the number of iterations has reached the prescribed number. If sufficient machine learning has been performed, the CPU 130 saves the trained model M that has learned the input-output relationship between the musical score feature amount sequence, as well as the input feature amount sequence, and the reference sound data sequence by training (Step S17) and terminates the training process. By the training process, the generative model m learns the correspondence between the input feature amount sequence (for example, input data (x)) and “the reference sound data sequence (for example, reference sound data sequence (x)), which is a sound data sequence corresponding to the input feature amount sequence,” which is attached to the input feature amount sequence as a label.

(6) Effects of the Embodiment

As described above, the sound generation method according to the present embodiment is realized by a computer, comprising receiving a first feature amount sequence in which a musical feature amount changes over time, and using a trained model, which has learned an input-output relationship between an input feature amount sequence in which the musical feature amount changes over time at a first fineness and a reference sound data sequence corresponding to an output feature amount sequence in which the musical feature amount changes over time at a second fineness that is higher than the first fineness, to process the first feature amount sequence, thereby generating a sound data sequence corresponding to a second feature amount sequence in which the musical feature amount changes at the second fineness. As described above, the term “musical feature amounts” indicates that the feature amounts are of a musical type (such as amplitude, pitch, timbre, etc.). The first feature amount sequence, the input feature amount sequence, the output feature amount sequence, and the second feature amount sequence are all examples of time-series data of a “musical feature amount.” That is, all of the feature amounts for which changes are shown in each of the first feature amount sequence, the input feature amount sequence, the output feature amount sequence, and the second feature amount sequence are “musical feature amounts.”

By this method, a sound data sequence that corresponds to the second feature amount sequence is generated even if the changes in the musical feature amount in the received first feature amount sequence are coarse (in other words, even if the musical feature amount changes slowly, in a discrete or intermittent manner, in the first feature amount sequence). In the second feature amount sequence, the musical feature amount changes finely (in other words, quickly and steadily or continuously), and a natural sound is generated from the sound data sequence. Therefore, it is not necessary for the user to input a detailed time series of the musical feature amount.

The musical feature amount at each point in time in the input feature amount sequence can indicate the representative value of the musical feature amount within the prescribed period of time including said time point in the output feature amount sequence.

The representative value can indicate a statistical value of the musical feature amount within the prescribed period of time in the output feature amount sequence.

The sound generation method can also present the reception screen 1 in which the first feature amount sequence is displayed along a time axis, and the first feature amount sequence can be input by the user using the reception screen 1. In this case, the user can easily input the first feature amount sequence while visually confirming the position of the musical feature amount in the first feature amount sequence on the time axis.

The fineness can indicate the frequency of change of the musical feature amount within a unit of time or the ratio of the high-frequency component content of the musical feature amount within a unit of time.

The sound generation method can also convert the sound data sequence representing a frequency-domain waveform into a time-domain waveform.

The training method according to the present embodiment is realized by a computer, and comprises extracting, from reference data representing a sound waveform, a reference sound data sequence in which a musical feature amount changes over time at a prescribed fineness and an output feature amount sequence which is a time series of the musical feature amount; generating, from the output feature amount sequence, an input feature amount sequence in which the musical feature amount changes over time at a lower fineness than the prescribed fineness; and constructing a trained model that has learned an input-output relationship between the input feature amount sequence and the reference sound data sequence by machine learning using the input feature amount sequence and the reference sound data sequence.

By this method, it is possible to construct a trained model M that can generate a sound data sequence that corresponds to the second feature amount sequence in which the musical feature amount changes with a high level of fineness (in other words, quickly and steadily or continuously) even if the changes in the musical feature amounts in the input first feature amount sequence are coarse (in other words, even if the musical feature amount changes slowly in a discrete or intermittent manner in the first feature amount sequence).

The input feature amount sequence can be generated by extracting, as the musical feature amount at each point in time in the input feature amount sequence, a representative value of the musical feature amount within the prescribed period of time including said time point in the output feature amount sequence.

The representative value can indicate a statistical value of the musical feature amount within the prescribed period of time in the output feature amount sequence.

The reference data can represent a time-domain sound waveform, and the reference sound data sequence can represent a frequency-domain sound waveform.

(7) Example Using a Feature Amount Other than Amplitude

In the first embodiment above, the user inputs the maximum amplitude value as the control value to control the generated sound signal, but the embodiment is not limited in this way. The control value can be another feature amount. The ways in which the sound generation device 10 and the training device 20 according to a second embodiment and the sound generation device 10 and the training device 20 according to the first embodiment differ and are the same will be described below.

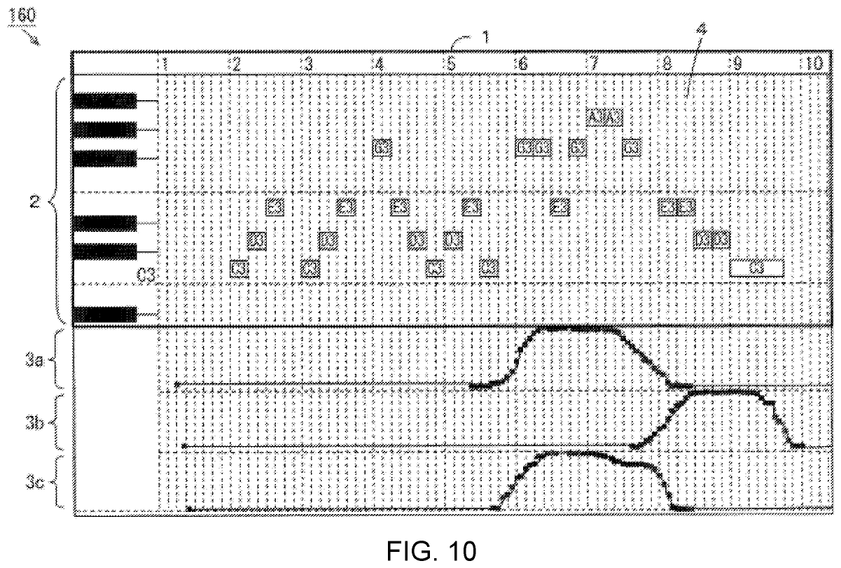

The sound generation device 10 according to this embodiment is the same as the sound generation device 10 of the first embodiment described with reference to FIG. 2 except in the following ways. The presentation unit 11 causes the display unit 160 to display the reception screen 1 based on the musical score data D3 selected by the user. FIG. 10 is a diagram showing an example of the reception screen 1 in the second embodiment. As shown in FIG. 10, in the reception screen 1 in this embodiment, three input areas, 3a, 3b, 3c, are arranged to correspond to the reference area 2 instead of the input area 3 of FIG. 3.

The user uses the operating unit 150 to input each feature amount of three first feature amount sequences in which the feature amounts (pitch variances, in this embodiment) in the three parts of the sound corresponding to each musical note displayed in the reference image 4 change over time, in the respective input areas 3a, 3b, 3c. This allows the first feature amount sequence to be input. As the first feature amount sequence, a time series of pitch variance of the attack part of the sound corresponding to the musical note is input in the input area 3a, a time series of pitch variance of the sustain part is input in the input area 3b, and pitch variance of the release part is input in the input area 3c. In the input example of FIG. 10, the pitch variance of the attack part and the release part in the sixth and seventh measures of the musical score is large, and the pitch variance of the sustain part in the eighth and ninth measures is large.

The generation unit 13 uses the trained model M to process the first feature amount sequence and the musical score feature amount sequence based on the musical score data D3, thereby generating the result data D1. The result data D1 include the second feature amount sequence, which is a time series of pitch that changes at a second fineness. The generation unit 13 can store the generated result data D1 in the storage unit 140 or the like. Based on the frequency-domain result data D1, the generation unit 13 generates a sound signal, which is a time-domain waveform, and supplies it to the sound system. The generation unit 13 can display the second feature amount sequence included in the result data D1 on the display unit 160.

The training device 20 in this embodiment is the same as the training device 20 of the first embodiment described with reference to FIG. 6 except in the following ways. In this embodiment, the time series of pitch, which is the output feature amount sequence to be extracted in Step S13 of the training process of FIG. 9, is already extracted as a part of the reference sound data sequence in the immediately preceding Step S12. In Step S13, the CPU 130 (extraction unit 21) extracts the time series of amplitude in each of the plurality of pieces of reference data D2, not as an output feature amount sequence, but as an index for separating the sound into three parts.

In the next Step S14, the CPU 130, based on the time series of amplitude, separates the time series of pitch (output feature amount sequence) included in the reference sound data sequence into a three-part time series, the attack part of the sound, the release part of the sound, and the body part of the sound between the attack part and the release part, and subjects each part to statistical analysis, thereby obtaining the time series of pitch variance (input feature amount sequence).

Further, in Steps S15-S16, the CPU 130 (constructing unit 23) repeatedly carries out machine learning (training of the generative model m) based on the reference sound data sequence generated from the reference data D2 and the reference musical score data D4 corresponding to the input feature amount sequence, thereby constructing the trained model M that has learned the input-output relationship between the musical score feature amount sequence, as well as the input feature amount sequence corresponding to the musical score data, and the reference sound data sequence corresponding to the output feature amount sequence.

In the sound generation device 10 according to this embodiment, the user can coarsely input the pitch variance of each time point as the first feature amount sequence, thereby effectively controlling the variation width of the high-fineness changing pitch of the sound that is generated at that time point. Further, by individually inputting the first feature amount for the three parts, it is possible to individually control the variation width of the pitch of the attack part, the body part, and the release part. The reception screen 1 includes the input areas 3a-3c, but the embodiment is not limited in this way. The reception screen 1 can omit one or two input areas from among the input areas 3a, 3b, 3c. The reception screen 1 need not include the reference area 2 in this embodiment as well. In this embodiment, the sound was controlled by making a division into three parts and inputting three pitch variance sequences, but one pitch variance sequence can be input in order to control the entire sound, from attack to release, without separation into three parts.

### Effects

By this disclosure, natural sound can be easily acquired.

What is claimed is:

1. A sound generation method realized by a computer, the sound generation method comprising:
receiving a first feature amount sequence in which a musical feature amount changes over time; and
using a trained model that has learned an input-output relationship between an input feature amount sequence in which the musical feature amount changes over time at a first fineness and a reference sound data sequence corresponding to an output feature amount sequence in which the musical feature amount changes over time at a second fineness that is higher than the first fineness, to process the first feature amount sequence, thereby generating a sound data sequence corresponding to a second feature amount sequence in which the musical feature amount changes at the second fineness.

2. The sound generation method according to claim 1, wherein
the musical feature amount at each time point in the input feature amount sequence indicates a representative value of the musical feature amount within each prescribed time period including each time point.

3. The sound generation method according to claim 2, wherein
the representative value indicates a statistical value of the musical feature amount within each prescribed time period in the output feature amount sequence.

4. The sound generation method according to claim 1, further comprising
presenting a reception screen in which the first feature amount sequence is displayed along a time axis, wherein
the receiving of the first feature amount sequence is performed by input of a user via the reception screen.

5. The sound generation method according to claim 1, wherein
each of the first fineness and the second fitness indicates a frequency of change of the musical feature amount within a unit of time, or a content ratio of a high-frequency component of the musical feature amount within the unit of time.

6. The sound generation method according to claim 1, further comprising
converting the sound data sequence representing a frequency-domain waveform into a time-domain waveform.

7. A training method realized by a computer, the training method comprising:
extracting, from reference data representing a sound waveform, a reference sound data sequence in which a musical feature amount changes over time at a prescribed fineness and an output feature amount sequence which is a time series of the musical feature amount;
generating, from the output feature amount sequence, an input feature amount sequence in which the musical feature amount changes over time at a lower fineness than the prescribed fineness; and
constructing a trained model that has learned an input-output relationship between the input feature amount sequence and the reference sound data sequence by machine learning that uses the input feature amount sequence and the reference sound data sequence.

8. The training method according to claim 7, wherein
the generating of the input feature amount sequence is performed by extracting, as the musical feature amount at each time point in the input feature amount sequence, a representative value of the musical feature amount within each prescribed time period including each time point in the output feature amount sequence.

9. The training method according to claim 8, wherein
the representative value indicates a statistical value of the musical feature amount within each prescribed time period in the output feature amount sequence.

10. The training method according to claim 7, wherein
the reference data represent the sound waveform in a time domain, and the reference sound data sequence represents the sound waveform in a frequency domain.

11. A sound generation device comprising:
at least one processor configured to
receive a first feature amount sequence in which a musical feature amount changes over time, and
use a trained model that has learned an input-output relationship between an input feature amount sequence in which the musical feature amount changes over time at a first fineness and a reference sound data sequence corresponding to an output feature amount sequence in which the musical feature amount changes over time at a second fineness that is higher than the first fineness, to process the first feature amount sequence, thereby generating a sound data sequence corresponding to a second feature amount sequence in which the musical feature amount changes at the second fineness.

12. The sound generation device according to claim 11, wherein
the musical feature amount at each time point in the input feature amount sequence indicates a representative value of the musical feature amount within each prescribed time period including each time point.

13. The sound generation device according to claim 12, wherein
the representative value indicates a statistical value of the musical feature amount within each prescribed time period in the output feature amount sequence.

14. The sound generation device according to claim 11, wherein
the at least one processor is further configured to present a reception screen in which the first feature amount sequence is displayed along a time axis, and
the at least one processor is configured to receive the first feature amount sequence through input of a user via the reception screen.

15. The sound generation device according to claim 11, wherein
each of the first fineness and the second fitness indicates a frequency of change of the musical feature amount within a unit of time, or a content ratio of a high-frequency component of the musical feature amount within the unit of time.

16. The sound generation device according to claim 11, wherein
the at least one processor is further configured to convert the sound data sequence representing a frequency-domain waveform into a time-domain waveform.

17. A training device comprising:
at least one processor configured to
extract, from reference data representing a sound waveform, a reference sound data sequence in which a musical feature amount changes over time at a prescribed fineness and an output feature amount sequence which is a time series of the musical feature amount,
generate, from the output feature amount sequence, an input feature amount sequence in which the musical feature amount changes over time at a lower fineness than the prescribed fineness, and
construct a trained model that has learned an input-output relationship between the input feature amount sequence and the reference sound data sequence by machine learning that uses the input feature amount sequence and the reference sound data sequence.

18. The training device according to claim 17, wherein
to generate the input feature amount sequence, the at least one processor is configured to extract, as the musical feature amount at each time point in the input feature amount sequence, a representative value of the musical feature amount within each prescribed time period including each time point in the output feature amount sequence.

19. A non-transitory computer readable medium storing a sound generation program that causes one or a plurality of computers to perform operations comprising:
receiving a first feature amount sequence in which a musical feature amount changes over time; and
using a trained model that has learned an input-output relationship between an input feature amount sequence in which the musical feature amount changes over time at a first fineness and a reference sound data sequence corresponding to an output feature amount sequence in which the musical feature amount changes over time at a second fineness that is higher than the first fineness to process the first feature amount sequence, thereby generating a sound data sequence corresponding to a second feature amount sequence in which the musical feature amount changes at the second fineness.

20. A non-transitory computer readable medium storing a training program that causes one or a plurality of computers to perform operations comprising:
extracting, from reference data representing a sound waveform, a reference sound data sequence in which a musical feature amount changes over time at a prescribed fineness and an output feature amount sequence that is a time series of the musical feature amount;
generating, from the output feature amount sequence, an input feature amount sequence in which the musical feature amount changes over time at a lower fineness than the prescribed fineness; and
constructing a trained model that has learned an input-output relationship between the input feature amount sequence and the reference sound data sequence by machine learning that uses the input feature amount sequence and the reference sound data sequence.
